(19) United States
(12) Patent Application Publication
(10) Pub. No.: US 2023/0195132 A1
(43) Pub. Date: Jun. 22, 2023

(54) Underground Exploration Device

(71) Applicant: Nippon Telegraph and Telephone Corporation, Tokyo (JP)

(72) Inventors: Shoji Mochizuki, Musashino-shi, Tokyo (JP); Masayuki Tsuda, Musashino-shi, Tokyo (JP)

(21) Appl. No.: 17/926,065

(22) PCT Filed: May 29, 2020
(86) PCT No.: PCT/JP2020/021357

§ 371 Date: Nov. 17, 2022

(51) Int. Cl. G05D 1/02; G01S 13/88; G01S 7/02; H02P 5/00

(52) U.S. Cl. CPC G05D 1/0268; G01S 7/027; G01S 13/885; G05D 1/027; G05D 1/0223; G05D 1/0272; H02P 5/00

(57) ABSTRACT

An underground exploration apparatus 100 that explores underground using electromagnetic waves includes a radar unit 1 for underground exploration including an antenna and a transceiver, three omni-directional movement type wheels 2a to 2c that are rotatably fixed to three wheel shafts arranged at 120 degrees intervals and can move the underground exploration apparatus in any direction by changing rotation directions and rotation speeds of the three wheels, three motors 3a to 3c that rotate the three wheels 2a to 2c in predetermined directions at predetermined speeds, a terminal 10 that controls the radar unit 1 and the three motors 3a to 3c. The terminal 10 includes a calculation unit 23 that calculates an external force applied to the underground exploration apparatus 100 using measurement data measured by three encoders 4a to 4c, three torque sensors 5a to 5c, an acceleration sensor 6, and a gyroscopic sensor 7, and a first control unit 26 that rotates the three motors 3a to 3c according to the external force.

### TECHNICAL FIELD

The present invention relates to an underground exploration apparatus.

### BACKGROUND ART

Underground exploration apparatuses for exploring underground using electromagnetic waves are known in the prior art. Such underground exploration apparatuses are used for a variety of purposes, such as for understanding the state of the underground, or searching for objects buried underground. The underground exploration apparatuses have a cart-like structure with wheels to be moved by human power for searching in areas where vehicle access is prohibited, such as on sidewalks and inside buildings, a side of a building where it is difficult to drive a vehicle, and areas where it is necessary to avoid obstacles.

Underground information can be obtained by moving the above-described underground exploration apparatus straight within a measurement area to be explored and scanning a ground surface with an antenna in the underground exploration apparatus. For example, the state and position of an underground space can be accurately obtained by measuring the amount of rotation of a wheel with an encoder at the same time that the measurement of underground exploration is performed while moving the underground exploration apparatus straight and by storing the measurement data of underground exploration in association with the movement distance data obtained from the amount of rotation of the wheel(see NPL 1).

In order to accurately obtain the state and position of the underground space, it is necessary to analyze the underground state by moving the underground exploration apparatus back and forth and right and left along a plurality of linear measurement lines at different measurement positions and measurement directions, and combining a plurality of pieces of measurement data. At this time, it is necessary to know relative positions among the plurality of measurement lines, but in order to know the relative positions, it is necessary to perform preliminary work of drawing the measurement lines within a measurement area and determine, in advance, start point positions and end point positions of the measurement lines individually in a two-dimensional coordinate system of the measurement area.

However, it takes a lot of time to perform the above preliminary work, determine the start point position and end point position of each measurement line, and align the end point of the previous measurement line with the start point of the following measurement line. In this regard, the use of omni-directional moving wheels that can move in all directions, such as omni-wheels or mecanum wheels, enables continuous two-dimensional movement within the measurement area and allows free and continuous scanning with two axes of freedom, so that the need for the above preliminary work can be eliminated (see NPLs 1 and 2).

### CITATION LIST

### Non Patent Literature

NPL 1: Emerson R. Almeida, et al., “Analysis of GPR field parameters for root mapping in Brazil’s caatinga environment”, Proc. of the 2018 International conference of Ground Penetrating Radar
NPL 2: Z. Liu, et al., “Novel Walking-Intention Recognition Method for Omnidirectional Walking Support Robot”, 2017 International Conference on Computer Technology, Electronics and Communication (ICCTEC), Dalian, China, 2017, 1048-1052
NPL 3: N. Matsumoto, et al., “Motion Control of a Walking Support Robot Based on Gait Analysis”, 2019 IEEE International Conference on Robotics and Biomimetics (ROBIO), Dali, China, 2019, 1881-1885

### SUMMARY OF THE INVENTION

### Technical Problem

However, since the omni-directional moving wheels allow the underground exploration apparatus to move in any direction within a 360-degree direction, it is difficult to move the underground exploration apparatus straight by human power, and unfortunately the scanning performance of the underground exploration apparatus is significantly low because, for example, the underground exploration apparatus cannot scan straight, or the posture of the underground exploration apparatus is not stable due to wobbling caused by skidding or turning motion while moving straight.

In recent years, a small-sized underground exploration apparatus has also been developed, but it is necessary to use different sizes of antennas depending on objects to be explored or the depth of exploration, and a large-sized antenna and a large-sized apparatus are used to explore a deep area. Regardless of the size of the apparatus, the underground exploration apparatus is commonly heavy. That is, it is difficult to handle the underground exploration apparatus by human power because the underground exploration apparatus is quite heavy, and a large amount of human power is needed to scan with the underground exploration apparatus. In this regard, it is possible to reduce a propulsive force used at the start of operation of the underground exploration apparatus by increasing the size of wheels to reduce contact resistance with traveling surfaces. However, since the initial operation from a stationary state requires a lot of forces, it is not a solution for the handling.

In addition, the processing speed of the underground exploration apparatus has been recently increased, and the acquisition interval of measurement data of underground exploration can be shortened, but when the underground exploration apparatus scans beyond a predetermined upper limit, measurement data is missed and it leads to a decrease in the quality of measurement data. However, it is difficult to maintain a constant scanning speed in scanning with the underground exploration apparatus by human power, and the speed easily exceeds the upper limit.

The present disclosure has been made in view of the above circumstances, and an object of the present disclosure is to provide a technique capable of improving work efficiency of underground exploration.

### Means for Solving the Problem

An underground exploration apparatus that explores underground using electromagnetic waves according to an aspect of the present disclosure includes a radar unit for underground exploration including an antenna and a transceiver; three omni-directional movement type wheels that is rotatably fixed to three wheel shafts arranged at 120 degrees intervals and moves the underground exploration apparatus in any direction by changing a rotation direction and rotation speed of each of the three wheels; three motors that rotates the three wheels in a predetermined direction at a predetermined speed; three encoders that measures an amount of rotation of each of the three wheels; three torque sensors that measures a torque of each of the three wheels; an acceleration sensor that measures an acceleration of the underground exploration apparatus; a gyroscopic sensor that measures a tilt angle and an angular velocity of the underground exploration apparatus; and a terminal that controls the radar unit and the three motors individually. The terminal includes a first communication unit that receives measurement data measured by the three encoders, the three torque sensors, the acceleration sensor, and the gyroscopic sensor and stores the measurement data in a first storage unit, a calculation unit that calculates an external force applied to the underground exploration apparatus using the measurement data and calculates an amount of movement of the underground exploration apparatus using the measurement data, a first control unit that rotates the three motors individually in response to the external force, a second communication unit that receives measurement data of underground exploration measured by the radar unit, and a second control unit that stores the measurement data of underground exploration in a second storage unit in association with the amount of movement of the underground exploration apparatus.

### Effects of the Invention

The present disclosure provides a technique capable of improving the work efficiency of underground exploration.

### BRIEF DESCRIPTION OF DRAWINGS

FIG. 1 is a top view illustrating a configuration of an underground exploration apparatus.

FIG. 2 is a configuration diagram illustrating a functional block configuration of a terminal.

FIG. 3 is a diagram illustrating driving methods for respective movement modes of the underground exploration apparatus.

FIG. 4 is an explanatory diagram of a principle of driving the underground exploration apparatus in all directions.

FIG. 5 is a flowchart illustrating operations of the underground exploration apparatus.

FIG. 6 is a flowchart illustrating an example of an external force in a selected direction.

FIG. 7 is a flowchart illustrating operations of the underground exploration apparatus.

FIG. 8 is a configuration diagram illustrating a hardware configuration of the terminal.

### DESCRIPTION OF EMBODIMENTS

Hereinafter, an embodiment of the present disclosure will be described with reference to the drawings.

### Summary of the Invention

The present disclosure discloses a technique for providing power assistance (torque assistance by motor drive) in a movement direction of an underground exploration apparatus that is capable of two-dimensional scanning and measurement of an amount of movement (movement distance), the underground exploration apparatus including an omni-directional movement mechanism. This technique makes it easy to transport and handle the underground exploration apparatus by human power and improves the work efficiency of underground exploration.

The present disclosure also discloses a technique for restricting a movement direction of the underground exploration apparatus to one direction (for example, rotation restriction), so that the underground exploration apparatus moves in one direction that is a movement direction of one movement mode selected from a plurality of movement modes with different movement directions. This technique can keep the rectilinearity of the underground exploration apparatus and suppress wobbling (skidding or turning while moving straight), and the work efficiency of underground exploration can be further improved.

The present disclosure also discloses a technique for providing power assistance (torque assistance by motor drive) so that a direction of an external force (human power, gravity, etc.) applied to the underground exploration apparatus matches a movement direction of the selected one movement mode. This technique can correct the movement direction of the underground exploration apparatus so that the trajectory in the selected movement direction does not shift, and thus the work efficiency of underground exploration can be further improved.

The present disclosure also discloses a technique for outputting warning information when a movement speed of the underground exploration apparatus approaches an upper limit movement speed. With this technique, the movement speed of the underground exploration apparatus can be optimized, the decrease in the quality of the measurement data of underground exploration can be suppressed, and the possibility of avoiding re-measurement of the underground exploration can be increased, so that the work efficiency of the underground exploration can be further improved.

### Configuration of Underground Exploration Apparatus

A configuration of the underground exploration apparatus according to the embodiment will be described.

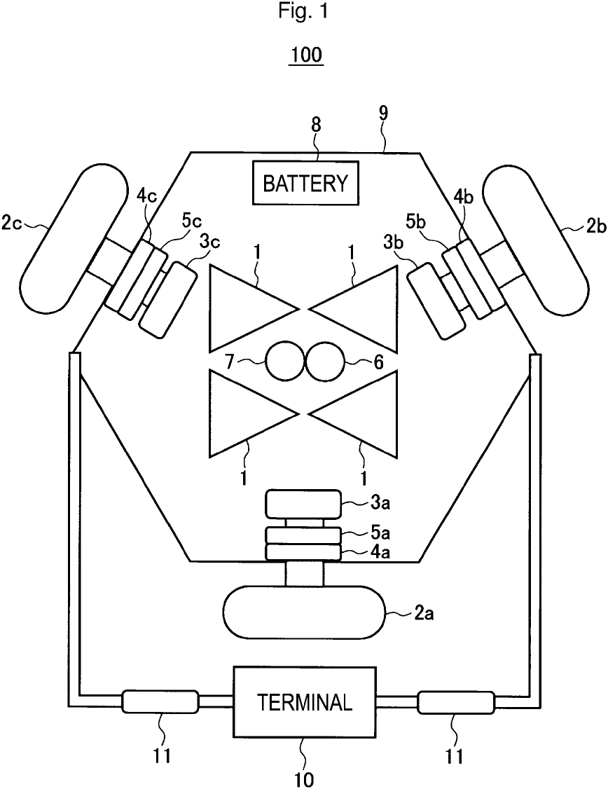

FIG. 1 is a top view of an underground exploration apparatus 100 according to the embodiment. The underground exploration apparatus 100 is an underground exploration apparatus for exploring underground using electromagnetic waves and has a cart-like structure with wheels. For example, the underground exploration apparatus 100 includes a radar unit 1, three wheels 2a to 2c, three motors 3a to 3c, three encoders 4a to 4c, three torque sensors 5a to 5c, an acceleration sensor 6, a gyroscopic sensor 7, a battery 8, a housing 9, and a terminal 10.

The radar unit 1 is a radar unit for underground exploration and includes an antenna and a transceiver that transmit electromagnetic waves toward the underground and receive electromagnetic waves reflected in the ground.

The three wheels 2a to 2c are rotatably fixed to three wheel shafts arranged at 120 degrees intervals, respectively. The three wheels 2a to 2c are omni-directional moving wheels that can move the underground exploration apparatus 100 in any direction by individually changing the rotation directions and rotation speeds (amounts of rotation) of the wheels. For example, the wheel 2a includes a disc-shaped wheel that rotates about the wheel shaft, and a plurality of small cylindrical rollers mounted on the circumference of the wheel at an angle of about 45 degrees to the wheel shaft. The angle of the small roller to the wheel shaft may be 30 degrees, 60 degrees, 90 degrees, or any other angle. Further, the wheel 2a may be formed by stacking a plurality of wheels apart from one another. In this way, since each of the three wheels 2a to 2c is provided with the plurality of small rollers on the circumference of each wheel, the underground exploration apparatus 100 can be moved in any direction by individually changing the rotation directions and rotation speeds of the three wheels, even when the three wheels are arranged in different directions by 120 degrees. For example, omni-wheels or mecanum wheels are used as the three wheels 2a to 2c.

Each of the three motors 3a to 3c has a function of rotating each of the three wheels 2a to 2c in a predetermined direction at a predetermined speed. That is, each of the three motors 3a to 3c provides a driving force and a braking force to each of the three wheels 2a to 2c. For example, the motor 3a changes the rotation direction of the wheel 2a by changing positive and negative of the voltage applied to the wheel 2a and changes the rotation speed (amount of rotation) of the wheel 2a by changing the magnitude of the voltage applied to the wheel 2a. The three motors 3a to 3c adjust the rotation directions and the rotation speeds of the wheels 2a to 2c, respectively, to control the movement direction of the underground exploration apparatus 100 in any direction. For example, commercially available motors can be used as the three motors 3a to 3c.

Each of the three encoders 4a to 4c is mounted near the wheel shaft of each of the three wheels 2a to 2c, and has a function of measuring an amount of rotation of each of the three wheels 2a to 2c. For example, the three encoders 4a to 4c are achieved using commercially available rotary encoders.

Each of the three torque sensors 5a to 5c is mounted near the wheel shaft of each of the three wheels 2a to 2c, and has a function of measuring a torque of each of the three wheels 2a to 2c. For example, commercial torque sensors can be used as the three torque sensors 5a to 5c.

One motor 3, one encoder 4, and one torque sensor 5 are included for each wheel 2.

The acceleration sensor 6 is installed at a center position of the underground exploration apparatus 100 and has a function of measuring acceleration of the underground exploration apparatus 100. For example, a commercially available acceleration sensor can be used as the acceleration sensor 6.

The gyroscopic sensor 7 is installed at a center position of the underground exploration apparatus 100 and has a function of measuring a tilt angle (tilting posture) and an angular velocity (turning motion) of the underground exploration apparatus 100. For example, a commercially available gyroscopic sensor can be used as the gyroscopic sensor 7.

One acceleration sensor 6 and one gyroscopic sensor 7 are included in each underground exploration apparatus 100.

The battery 8 has a function of supplying electric power to the radar unit 1, the three motors 3a to 3c, the three encoders 4a to 4c, the three torque sensors 5a to 5c, the acceleration sensor 6, the gyroscopic sensor 7, and the terminal 10. For example, a commercially available battery can be used as the battery 8.

The housing 9 forms a body part of the underground exploration apparatus 100 and has a function of housing the radar unit 1, the three shafts, the three motors 3a to 3c, the three encoders 4a to 4c, the three torque sensors 5a to 5c, the acceleration sensor 6, the gyroscopic sensor 7, and the battery 8 inside.

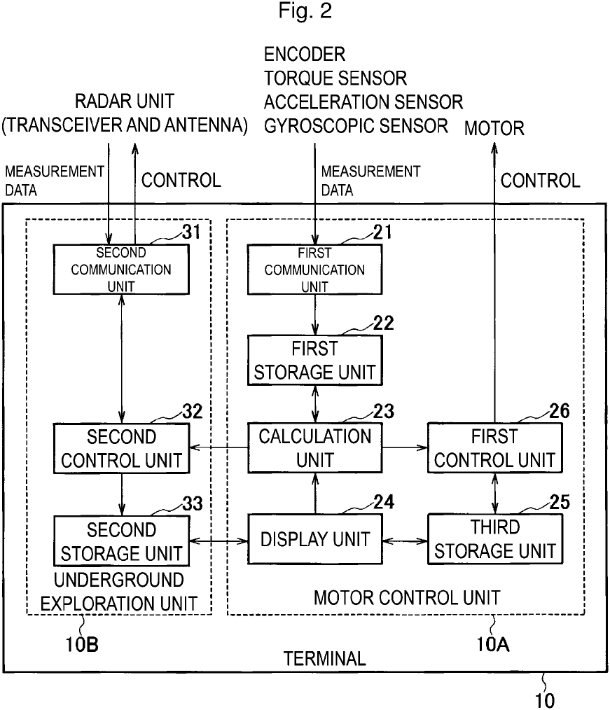

The terminal 10 is installed on a frame with a pair of handles 11 for both hands for moving the underground exploration apparatus 100 (housing 9) by human power and has a function of individually controlling the radar unit 1 and the three motors 3a to 3b. The terminal 10 is a computer with a touch panel function and includes a motor control unit 10A and an underground exploration unit 10B as illustrated in FIG. 2.

The motor control unit 10A will be described. The motor control unit 10A includes a first communication unit 21, a first storage unit 22, a calculation unit 23, a display unit 24, a third storage unit 25, and a first control unit 26.

The first communication unit 21 has a function of receiving measurement data measured by the three encoders 4a to 4c, the three torque sensors 5a to 5c, the acceleration sensor 6, and the gyroscopic sensor 7, and storing the measurement data in the first storage unit 22.

The first storage unit 22 has a function of storing the above measurement data.

The calculation unit 23 has a function of reading the above measurement data from the first storage unit 22, calculating an external force (human power, gravity, etc.) applied to the underground exploration apparatus 100 using the measurement data, and passing the value of the external force to the first control unit 26.

The calculation unit 23 also has a function of reading the above measurement data from the first storage unit 22, calculating an amount of movement (movement distance) of the underground exploration apparatus 100 using the measurement data, and passing the amount of movement of the underground exploration apparatus 100 to a second control unit 32.

The calculation unit 23 also has a function of passing information regarding the movement direction of one movement mode selected by a user from the plurality of movement modes displayed on the display unit 24 to the first control unit 26.

The calculation unit 23 also has a function of reading the above measurement data from the first storage unit 22, calculating the movement speed of the underground exploration apparatus 100 using the measurement data, and when the movement speed approaches the upper limit movement speed, outputting warning information to the display unit 24 indicating that the underground exploration apparatus 100 approaches the upper limit movement speed. With this function, the movement speed of the underground exploration apparatus 100 can be optimized, the decrease in the quality of the measurement data of underground exploration can be suppressed, and the possibility of avoiding re-measurement of underground exploration can be increased, so that the work efficiency of the underground exploration can be improved.

The display unit 24 has a function of reading the movement mode information indicating the plurality of movement modes with different movement directions from the third storage unit 25, displaying the movement mode information on the touch panel screen, and notifying the calculation unit 23 of information regarding the movement direction of one movement mode selected by the user.

The display unit 24 also has a function of displaying the above warning information on the touch panel screen. When the display unit 24 has a built-in audio function, the display unit 24 may output a warning sound based on the warning information.

The third storage unit 25 has a function of storing the above movement mode information (movement mode information indicating the plurality of movement modes with different movement directions).

The first control unit 26 has a function of receiving a value of an external force (human power, gravity, etc.) applied to the underground exploration apparatus 100 from the calculation unit 23 and rotating the three motors 3a to 3c individually in accordance with the value of the external force. For example, when the underground exploration apparatus 100 is not motor-driven but is moved by the external force, the three motors 3a to 3c are driven in response to the external force (power assistance; torque assistance by motor drive). This function makes it easy to transport and handle the underground exploration apparatus 100 by human power, and the work efficiency of underground exploration can be improved.

The first control unit 26 also has a function of receiving information regarding the movement direction of one movement mode selected by the user from the calculation unit 23, and individually controlling the rotation directions and rotation speeds of the three motors 3a to 3c (rotation restriction control, etc.), so that the underground exploration apparatus 100 moves only in one direction which is the selected movement direction. This function can keep the rectilinearity of the underground exploration apparatus 100 and suppress wobbling, so that the work efficiency of underground exploration can be further improved.

The first control unit 26 also has a function of receiving the value of the external force applied to the underground exploration apparatus 100 from the calculation unit 23, and further receiving the information regarding the movement direction of the one movement mode selected by the user from the calculation unit 23, and individually controlling the rotation directions and the rotation speeds of the three motors 3a to 3c (power assistance; torque assistance by motor drive), so that the direction of the external force matches the movement direction of the selected one movement mode. This function can correct the movement direction of the underground exploration apparatus 100 so that the trajectory in the selected movement direction does not shift, and thus the work efficiency of underground exploration can be further improved.

Next, the underground exploration unit 10B will be described. The underground exploration unit 10B includes a second communication unit 31, the second control unit 32, and a second storage unit 33.

The second communication unit 31 has a function of transmitting and receiving various signals and various data to be used by the second control unit 32 for performing underground exploration. For example, the second communication unit 31 transmits a start signal or an end signal for underground exploration to the radar unit 1 and receives the measurement data of underground exploration measured by the radar unit 1.

he second control unit 32 has a function of performing underground exploration. The second control unit 32 also has a function of receiving, from the calculation unit 23, the amount of movement (movement distance) of the underground exploration apparatus 100 calculated during performing the underground exploration. For example, the second control unit 32 transmits the start signal for underground exploration to the radar unit 1 via the second communication unit 31, and stores the measurement data of underground exploration returned from the radar unit 1 in the second storage unit 33 in association with the amount of movement of the underground exploration apparatus 100.

The second storage unit 33 has a function of storing measurement result information of underground exploration including the measurement data of underground exploration and the amount of movement (movement distance) of the underground exploration apparatus 100. This measurement result information of underground exploration is displayed on the touch panel screen by the display unit 24.

With the configuration of the apparatus illustrated in FIGS. 1 and 2, the underground exploration apparatus 100 can perform two-dimensional scanning back and forth and right and left by human power, record the traveling trajectory, display the measurement data of underground exploration within the measurement area while scanning two-dimensionally, and improve the work efficiency of underground exploration.

Note that the functional block configuration of the terminal 10 illustrated in FIG. 2 is an example. A single functional unit may include a plurality of functional units, or a single functional unit may be divided into a plurality of functional units.

### Basic Operation of Underground Exploration Apparatus

Next, the basic operation of the underground exploration apparatus 100 will be described.

As illustrated in FIG. 1, in the embodiment, omni-directional moving wheels such as omni-wheels or mecanum wheels are used as the three wheels 2a to 2c. Each of the three wheels 2a to 2c is provided with each of the three motors 3a to 3c that drives each of the three wheels, each of the three encoders 4a to 4c that manages the amount of rotation of each of the three wheels, and each of the three torque sensors 5a to 5c that manages the torque of each of the three wheels. The three wheels 2a to 2c are arranged so that the rotation directions of the wheels differ from one another by 120 degrees.

First, the calculation unit 23 of the terminal 10 calculates a movement direction vector and a movement speed vector of the underground exploration apparatus 100 due to the external force based on the amounts of rotation and the wheel diameters of the wheels 2a to 2c, and obtains the movement distance of the underground exploration apparatus 100 on two dimensions within the measurement area. Subsequently, the calculation unit 23 calculates the voltage values required for driving the motor based on the speed information and the torque information. Finally, the first control unit 26 individually controls the three encoders 4a to 4c using signals with the voltage values.

Basically, a person’s driving force triggers the motor control, and power assistance is provided to the person’s driving force. Further, the above speed information (movement direction vector and movement speed vector) is used as feedback information to provide the power assistance so that the movement direction of the underground exploration apparatus 100 matches the selected one direction.

As illustrated in FIG. 1, the underground exploration apparatus 100 further includes the acceleration sensor 6 and the gyroscopic sensor 7. The calculation unit 23 of the terminal 10 collects acceleration data, and a tilt angle, and an angular velocity data, calculates the movement direction and degree of wobbling of the underground exploration apparatus 100 based on the acceleration data, and calculates the tilting posture and a turning motion value of the underground exploration apparatus 100 based on the tilt angle and the angular velocity data. The terminal 10 uses those data as feedback information for the balance adjustment of the underground exploration apparatus 100.

As illustrated in FIG. 1, the underground exploration apparatus 100 further includes the radar unit 1 for transmitting and receiving electromagnetic waves. The second control unit 32 of the terminal 10 gives a measurement start command to the radar unit 1 to start underground exploration, and stores and displays the measurement data for underground exploration.

In other words, the underground exploration apparatus 100 according to the embodiment controls the motor based on the external force. This allows scanning with less human power, scanning only in the desired direction or specified direction, and scanning at the desired speed. The movement directions that can be scanned with the underground exploration apparatus 100 are set in advance as “movement modes” and only one movement mode is allowed to be selected.

### Movement Mode

In motor control, a driving force can be generated by rotating the motor, and a static force can also be generated by stopping the motor. In a case of omni-directional moving wheels with three wheels, the rotation direction and rotation speed (amount of rotation) of each wheel are uniquely determined by the movement direction of forward, backward, rightward, leftward, or turning, so that the underground exploration apparatus 100 can be easily moved in the desired direction. In addition, when all three wheels are stopped, a stopping state can be created. Further, when all three wheels are not subjected to a braking force, a free state can be created in which two-dimensional and turning motions are possible.

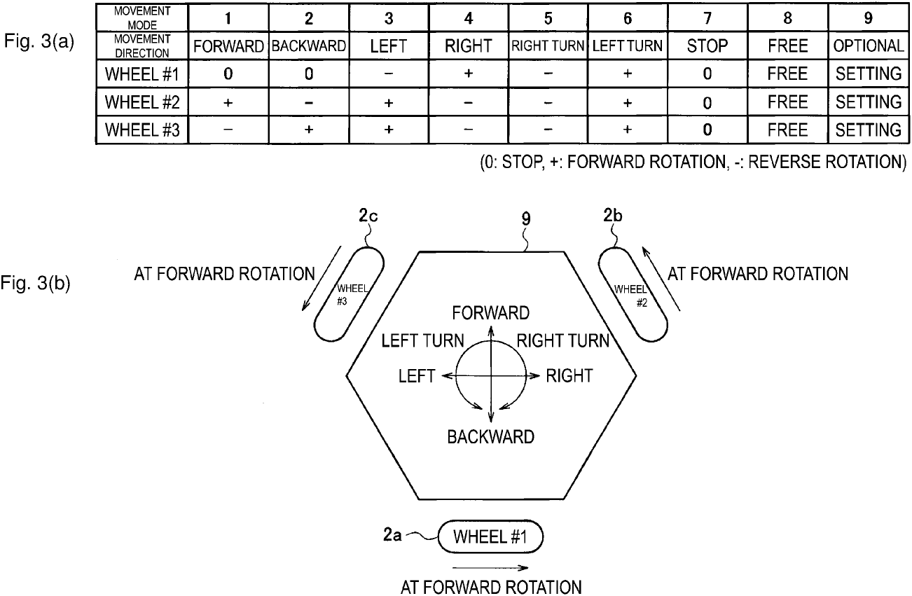

In the embodiment, in order to restrict (lock) the movement direction of the underground exploration apparatus 100 to only one direction, the “movement modes” are provided for manual scanning. As the movement modes, nine types of movement directions are provided (FIG. 3(a)). The nine types of movement directions are, for example, forward, backward, left, right, right turn, left turn, stop, free, and any direction. Since the movement direction of the underground exploration apparatus 100 is determined by the composite of the movement direction vectors of the wheels 2a to 2c, controlling each wheel as illustrated in FIG. 3(a) is sufficient to move in each movement direction. When the directions of the arrows in FIG. 3(b) indicate positive rotation directions of the three wheels, the rotation directions of the three wheels {0 (stop), + (forward rotation), - (reverse rotation)} for each movement direction of the underground exploration apparatus 100 are indicated in FIG. 3(a).

For example, when moving the underground exploration apparatus 100 straight forward, the rotation of the wheel 2a is restricted (locked) to “0”, the rotation direction of the wheel 2b to “+”, and the rotation direction of the wheel 2c to “-”. In addition, although not illustrated in FIG. 3, the magnitudes of the voltages applied to the two wheels 2b and 2c are equally restricted (locked) so that the rotation speeds of the two wheels 2b and 2c are equal. Further, the timings of applying each voltage to the two wheels 2b and 2c are restricted (locked) to simultaneous timing.

When the underground exploration apparatus 100 is moved with these restrictions applied, the underground exploration apparatus 100 moves straight forward. Because the plurality of small rollers are attached to each of the wheels 2a to 2c at an angle of approximately 45 degrees to each of the wheel shafts, each of the two non-parallel left and right wheels 2b and 2c rotates in a forward direction, and at the same time, the plurality of small rollers provided on each of the wheels also rotate. The small rollers of the wheel 2a also rotate. A propulsive force slightly inward due to the rotation of each of the two wheels 2b and 2c also acts outward due to the rotation of the small rollers, so that the underground exploration apparatus 100 moves straight forward.

In addition, in a stop mode, the underground exploration apparatus 100 can be stopped by stopping all the wheels 2a to 2c. In a free mode, by releasing the restrictive restraint of all the wheels 2a to 2c, the underground exploration apparatus 100 can scan freely. An optional mode is a mode in which a direction and speed to be moved is freely determined. In any mode, the movement direction is restricted to one direction, so that linear scanning without wobbling is possible.

### Movement Mode Selection Example 1

For example, in exploring a measurement area in a narrow space or a measurement area with obstacles, it is difficult to scan in one direction, and the underground exploration apparatus 100 needs to make a small turn. In such a case, the free mode is selected so that the underground exploration apparatus 100 can be manually and freely moved without assistance and restriction (locking) of the driving force or braking force by the motor. By scanning in the free mode, the exploration can be performed easily.

### Movement Mode Selection Example 2

For example, in exploring a measurement area including a long-distance section, the front mode, the rear mode, the left mode, or the right mode is selected. This makes it possible to move the underground exploration apparatus 100 linearly and also perpendicularly with the assistance of the motor, so that parallel measurement lines can be easily obtained. Properly spaced data to be obtained facilitates the integration of measurement data and improve the quality of the integrated data. In addition, scanning in only one direction has been possible so far, but the omni-directional movement mechanism enables the underground exploration apparatus 100 to perform round-trip exploration with a single stroke, so that the work time can be dramatically reduced.

### Principle of Omni-Directional Drive of Underground Exploration Apparatus

Next, a principle of drive that makes it possible to move the underground exploration apparatus 100 in any direction with the three wheels will be described.

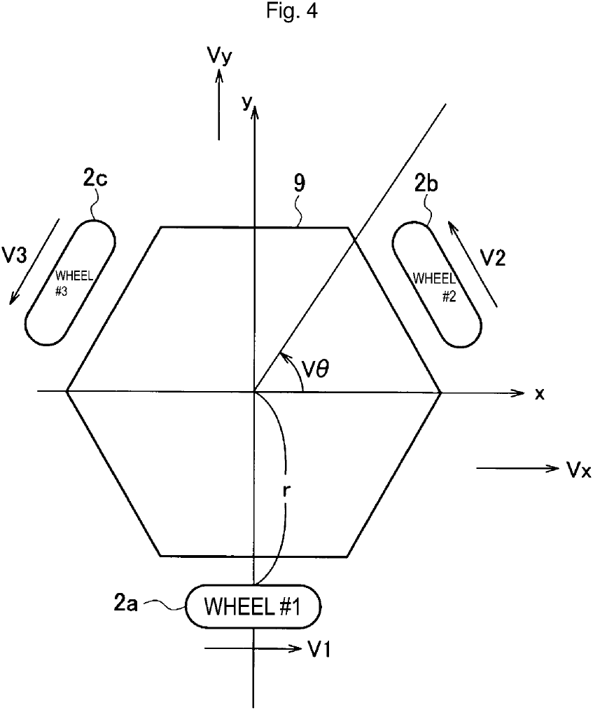

For example, as illustrated in FIG. 4, when assuming that the speed required for rightward movement is Vx, the speed required for upward movement is Vy, and the speed required for the leftward rotation is V6, the speeds V1 to V3 required for the three wheels 2a to 2c are expressed in Equation (1) from the relative positions between the three wheels 2a to 2c. r is a distance (specified value) from a center of the housing 9 to each of the wheels 2a to 2c. [0077]

$$V = \left(\begin{matrix}{V}_{1} \\ {V}_{2} \\ {V}_{3}\end{matrix}\right) = \left(\begin{matrix}1 & 0 & r \\ - 1 / 2 & \sqrt{3 / 2} & r \\ - 1 / 2 & - \sqrt{3 / 2} & r\end{matrix}\right) \left(\begin{matrix}{V}_{x} \\ {V}_{y} \\ {V}_{θ}\end{matrix}\right)$$

At this time, V1 to V3 are calculated by substituting the values corresponding to a desired movement direction into the Vx, Vy, and V8, and the underground exploration apparatus 100 can be driven in the desired movement direction by driving the wheels 2a to 2c with the calculated V1 to V3, respectively. For example, when moving the underground exploration apparatus 100 in a forward direction, Vx = 0, Vy = 1, V6 = 0 are substituted into Equation (1). When Equation (1) is calculated, V1 = 0, V2 ≈ 0.87, and V3 ≈ -0.87 are established, and the wheels 2a to 2c may be driven at these speed values, respectively.

### Auxiliary Operation in Selected Movement Direction

Next, the auxiliary operation in a movement direction by driving the motor in a selected movement direction will be described.

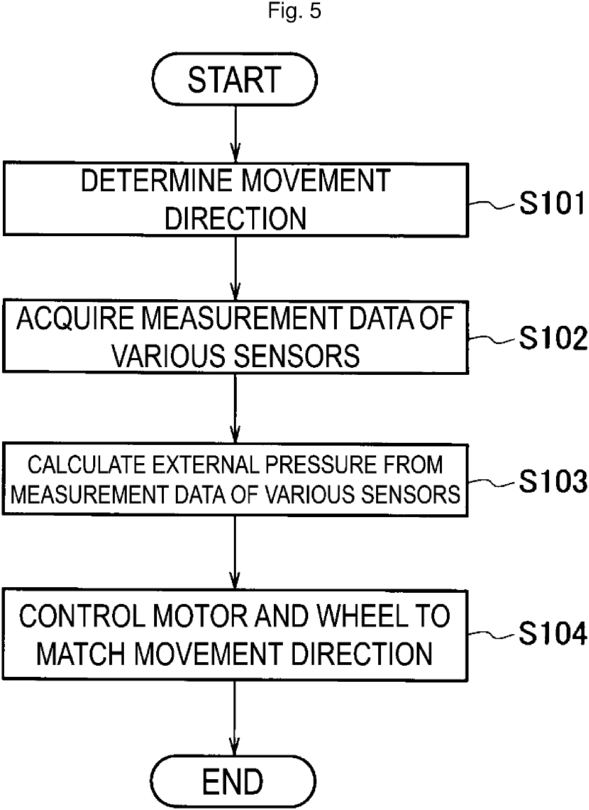

FIG. 5 is a flowchart illustrating the operation of the underground exploration apparatus 100. In manually scanning with the underground exploration apparatus 100 provided with the three-wheel omni-directional movement mechanism, the movement direction is selected from the movement mode information. Then, the three motors 3a to 3c are controlled to apply the driving force or braking force to the wheels 2a to 2c, respectively, so that the underground exploration apparatus 100 moves in the selected movement direction. This maintains the trajectory in the selected movement direction. A detail will be described below.

### Step S101

First, the display unit 24 of the terminal 10 displays the movement mode information on the touch panel screen, which indicates nine types of movement modes with different movement directions. The display unit 24 then notifies the calculation unit 23 of information regarding the movement direction of one movement mode selected by the user from the nine types of movement modes. In the example, it is assumed that the forward direction is selected. Then, it is assumed that the user performs underground exploration while moving the underground exploration apparatus 100 forward by human power.

### Step S102

Subsequently, the first communication unit 21 receives measurement data measured by the three encoders 4a to 4c, the three torque sensors 5a to 5c, the acceleration sensor 6, and the gyroscopic sensor 7 in accordance with the forward movement of the underground exploration apparatus 100 by human power.

### Step S103

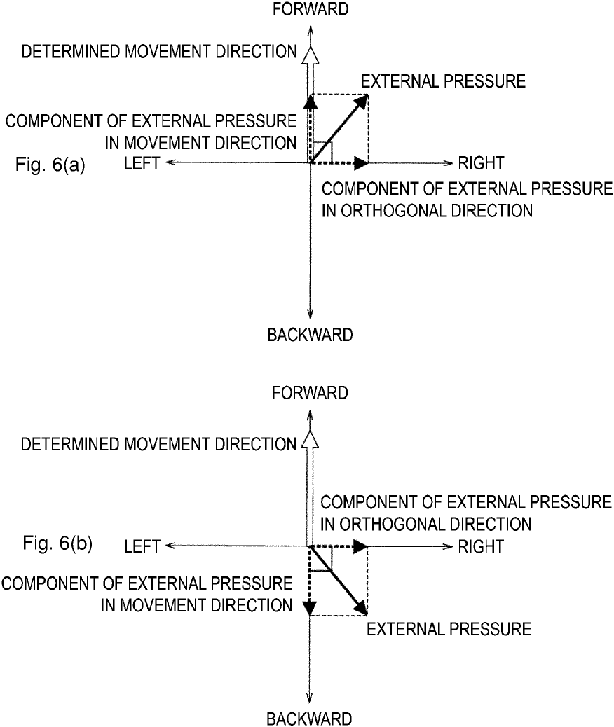

Subsequently, the calculation unit 23 calculates the human power applied to the underground exploration apparatus 100 based on the received measurement data, and separates the human power into a component in the above selected movement direction and a component orthogonal to the component in the movement direction. FIG. 6(a) illustrates a case in which human power (driving force for acceleration) is applied slightly rightward and forward to the selected forward direction. In this case, the human power is separated into the forward direction and the right direction. FIG. 6(b) illustrates a case in which human power (braking force for deceleration) is applied slightly rightward and rearward to the selected forward direction. In this case, the human power is separated into a rear direction and a right direction. The calculation unit 23 then passes the component in the movement direction and the component orthogonal to the movement direction obtained by the human power, to the first control unit 26.

### Step S104

Finally, the first control unit 26 controls the magnitude of acceleration or deceleration of the motor in accordance with the magnitude of the component in the movement direction. Specifically, the first control unit 26 controls the driving force or braking force of the motor with the force proportional to the magnitude of the component in the movement direction. In the case of FIG. 6(a), the motor is driven so as to move in the same direction (forward direction) as the direction in which the underground exploration apparatus 100 is accelerated. In the case of FIG. 6(b), the motor is driven so as to move in the same direction (rearward direction) as the direction in which the underground exploration apparatus 100 is decelerated. This makes it easy to accelerate and decelerate the underground exploration apparatus 100.

The first control unit 26 controls the motor so as to cancel the force in the orthogonal component direction. In the cases of FIG. 6(a) and (b), the motor is driven with the same magnitude as the magnitude of the orthogonal component so that the underground exploration apparatus 100 moves in a left direction. When the movement speed is zero, motor drive for acceleration or deceleration is not performed. By accelerating or decelerating only when the external force is applied, and by moving at constant speed otherwise, stable measurement at a constant speed is possible.

In addition, the first control unit 26 may use the minute change in acceleration measured by the acceleration sensor 6 for minute adjustment of the motor driving force. The acceleration sensor 6 provides a highly sensitive directional component that cannot be obtained from the speed vector of the wheel 2, and by reflecting the highly sensitive directional component as a fine adjustment of the motor control, stable traveling can be achieved.

Further, the first control unit 26 may generate the motor driving force so as to cancel the tilt measured by the gyroscopic sensor 7. The gyroscopic sensor 7 calculates the tilting posture of the underground exploration apparatus 100 and generates the force correcting a slippery direction to a less slippery direction, so that the underground exploration apparatus 100 can be allowed to make a linear motion even on a slope or the like.

### Warning Operation Associated With Movement Speed

Next, warning operation when the movement speed of the underground exploration apparatus approaches the upper limit movement speed will be described.

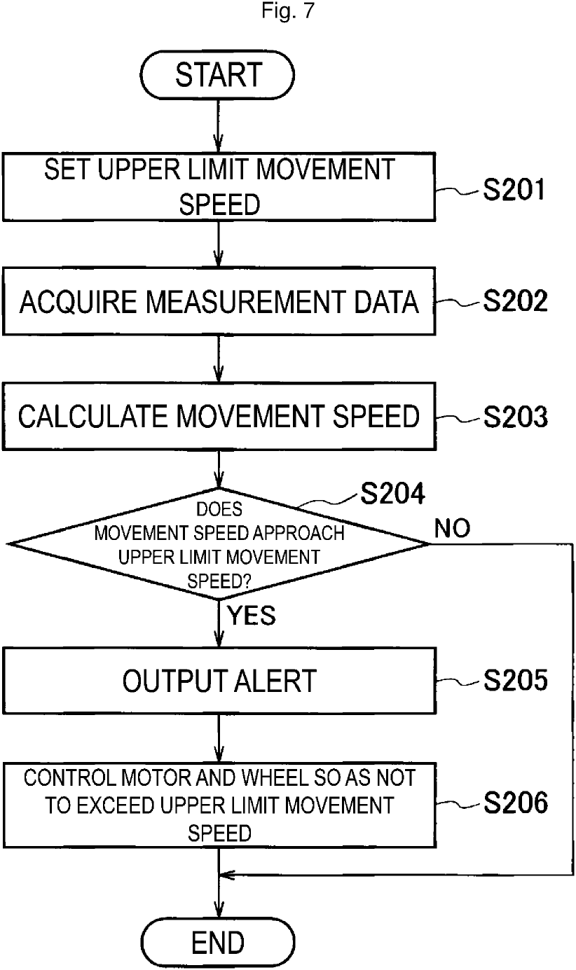

FIG. 7 is a flowchart illustrating the operation of the underground exploration apparatus 100. The underground exploration apparatus 100 can combine speed vectors of the three wheels, calculate a speed vector of the underground exploration apparatus 100, and monitor the speed of the underground exploration apparatus 100. An upper limit movement speed is set for the movement speed of the underground exploration apparatus 100, warning information is output when the movement speed approaches the upper limit, and the motor is controlled so that the movement speed does not exceed the upper limit movement speed. A detail will be described below.

### Step S201

First, the calculation unit 23 holds the upper limit movement speed of the underground exploration apparatus 100 input by the user. Then, it is assumed that the user performs underground exploration while moving the underground exploration apparatus 100 in a desired direction by human power.

### Step S202

Subsequently, the first communication unit 21 receives measurement data measured by the three encoders 4a to 4c, the three torque sensors 5a to 5c, the acceleration sensor 6, and the gyroscopic sensor 7 in accordance with the forward movement of the underground exploration apparatus 100 by human power.

### Step S203

Subsequently, the calculation unit 23 calculates the movement speed of the underground exploration apparatus 100 based on the received measurement data.

### Step S204

Subsequently, the calculation unit 23 determines whether the calculated movement speed of the underground exploration apparatus 100 approaches the upper limit movement speed. When the movement speed of the underground exploration apparatus 100 approaches the upper limit movement speed, the process proceeds to step S205, and when the movement speed of the underground exploration apparatus 100 does not approach the upper limit movement speed, the process ends.

### Step S205

When the movement speed of the underground exploration apparatus 100 approaches the upper limit movement speed, the calculation unit 23 outputs warning information to the display unit 24 indicating that the underground exploration apparatus 100 approaches the upper limit movement speed.

### Step S205

In addition, when the movement speed of the underground exploration apparatus 100 approaches the upper limit movement speed, the first control unit 26 reduces the rotation speed of each of the motors 3a to 3c so as not to exceed the upper limit movement speed.

Note that when the movement speed exceeds the upper limit movement speed, the underground exploration apparatus 100 may output warning information indicating that the underground exploration apparatus 100 has exceeded the upper limit movement speed.

### Other Configurations

A separate physical on/off switch may be prepared for emergency stop, so that all three wheels 2a to 2c can be stopped. This makes it possible to improve safety in an emergency. It is also possible to keep the underground exploration apparatus 100 in the stop mode at all times and provide a contact sensor or the like on the handle 11, so that the movement mode can be selected only when the user is authenticated by the contact sensor, and the stop mode can be released to allow scanning. By applying such an authentication system, a theft of the underground exploration apparatus 100 can be prevented.

### Effects

According to the embodiment, the calculation unit 23 of the terminal 10 calculates the external force applied to the underground exploration apparatus 100 based on the measurement data measured by the three encoders 4a to 4c, the three torque sensors 5a to 5c, the acceleration sensor 6, and the gyroscopic sensor 7, and the first control unit 26 rotates the three motors 3a to 3c individually in response to the external force, so that transportation and handling of the underground exploration apparatus by human power are facilitated and the work efficiency of underground exploration can be improved.

Further, according to the embodiment, the first control unit 26 individually controls the rotation directions and the rotation speeds of the three motors 3a to 3c so that the underground exploration apparatus 100 moves only in one direction which is the movement direction of the one movement mode selected from the plurality of movement modes, so that the rectilinearity of the underground exploration apparatus 100 can be kept, the wobbling (skidding, turning, etc. while moving straight) can be suppressed, and the work efficiency of underground exploration can be further improved.

Furthermore, according to the embodiment, the first control unit 26 performs torque assist control to individually control the rotation directions and the rotation speeds of the three motors 3a to 3c so that the direction of the external force applied to the underground exploration apparatus 100 matches the movement direction of the selected one movement mode. Thus, the movement direction of the underground exploration apparatus 100 can be corrected so that the trajectory in the selected movement direction does not shift, and the work efficiency of underground exploration can be further improved.

Further, according to the embodiment, when the movement speed of the underground exploration apparatus 100 approaches the upper limit movement speed, the calculation unit 23 outputs warning information indicating that the underground exploration apparatus 100 approaches the upper limit movement speed, so that the movement speed of the underground exploration apparatus can be optimized, the decrease in the quality of the measurement data of underground exploration can be suppressed, the possibility of avoiding the re-measurement of underground exploration can be increased, and the work efficiency of the underground exploration can be further improved.

In other words, the underground exploration apparatus 100 according to the embodiment which is capable of two-dimensional scanning and turning motion can improve the work efficiency by eliminating the burden of preliminary work, alignment work, and the like. In addition, the underground exploration apparatus 100 detects the force for driving or braking by a person, drives the motor so that the driving force or braking force is generated only in a determined movement direction, and individually controls the amounts of rotation of the wheels, so that wobbling during scanning is reduced and the rectilinearity is improved. Although the underground exploration apparatus 100 is a heavy object, the force required for scanning can be reduced by detecting the force driven by a person and supplementing the driving force with the motor.

The scanning speed can be obtained by individually monitoring the amounts of rotation of the wheels, and the speed can be controlled by motor control so as not to exceed the maximum scanning speed. By monitoring the scanning state and the posture state with the acceleration sensor and the gyroscopic sensor, and reflecting the monitored states in the motor control as necessary, it is possible to measure data with stable scanning and posture. In addition, since information regarding skidding and turning can be obtained from the acceleration sensor and the gyroscopic sensor, it is possible to reduce measurement errors that cannot be reflected in the movement distance obtained from the amount of rotation of the wheel, which is useful for high accuracy of the movement distance. The motor control makes it possible to move at a constant speed.

### Hardware Configuration of Terminal

The present invention is not limited to the embodiment described above. The present invention can be variously modified within the scope of the gist of the present invention.

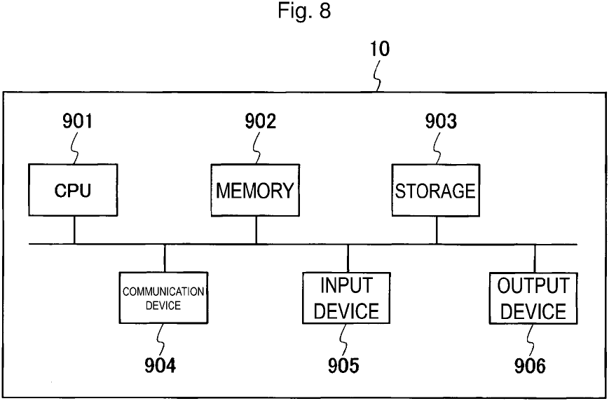

The terminal 10 according to the above-described embodiment can be implemented, as illustrated in FIG. 8, for example, using a general-purpose computer system including a central processing unit (CPU; processor) 901, a memory 902, a storage (HDD; hard disk drive or SSD; solid state drive) 903, a communication device 904, an input device 905, and an output device 906. The memory 902 and the storage 903 are storage devices. In the computer system, each function of the terminal 10 is achieved by the CPU 901 executing a predetermined program loaded on the memory 902.

The terminal 10 may be implemented in one computer. The terminal 10 may be implemented in a plurality of computers. The terminal 10 may be a virtual machine implemented in a computer. A program for the terminal 10 may be stored in a computer-readable recording medium such as an HDD, an SSD, a universal serial bus (USB) memory, a compact disc (CD), a digital versatile disc (DVD) or the like. The program for the terminal 10 may also be distributed via a communication network.

### REFERENCE SIGNS LIST

1: Radar unit
2a to 2c: Wheel
3a to 3c: Motor
4: Encoder
5: Torque sensor
6: Acceleration sensor
7: Gyroscopic sensor
8: Battery
9: Housing
10: Terminal
10A: Motor control unit
10B: Underground exploration unit
11: Handle
21: First communication unit
22: First storage unit
23: Calculation unit
24: Display unit
25: Third storage unit
26: First control unit
31: Second communication unit
32: Second control unit
33: Second storage unit
901: CPU
902: Memory
903: Storage
904: Communication device
905: Input device
906: Output device

1. An underground exploration apparatus configured to explore underground using electromagnetic waves, the underground exploration apparatus comprising:
a radar unit for underground exploration including an antenna and a transceiver;
three omni-directional movement type wheels rotatably fixed to three wheel shafts arranged at 120 degrees intervals and configured to move the underground exploration apparatus in any direction by changing a rotation direction and rotation speed of each of the three wheels;
three motors configured to rotate the three wheels in a predetermined direction at a predetermined speed;
three encoders configured to measure an amount of rotation of each of the three wheels;
three torque sensors configured to measure a torque of each of the three wheels;
an acceleration sensor configured to measure an acceleration of the underground exploration apparatus;
a gyroscopic sensor configured to measure a tilt angle and an angular velocity of the underground exploration apparatus; and
a terminal configured to control the radar unit and the three motors individually, wherein the terminal includes
a first communication unit configured to receive measurement data measured by the three encoders, the three torque sensors, the acceleration sensor, and the gyroscopic sensor, and store the measurement data in a first storage unit,
a calculation unit configured to calculate an external force applied to the underground exploration apparatus using the measurement data and calculate an amount of movement of the underground exploration apparatus using the measurement data,
a first control unit configured to rotate the three motors individually in response to the external force,
a second communication unit configured to receive measurement data of underground exploration measured by the radar unit, and
a second control unit configured to store the measurement data of underground exploration in a second storage unit in association with the amount of movement of the underground exploration apparatus.

2. The underground exploration apparatus according to claim 1, further comprising:
a third storage unit configured to store movement mode information indicating a plurality of movement modes with different movement directions, wherein
the first control unit controls a rotation direction and a rotation speed of each of the three motors to move the underground exploration apparatus in one direction that is a movement direction of one movement mode selected from the plurality of movement modes.

3. The underground exploration apparatus according to claim 2, wherein the first control unit performs torque assist control that controls the rotation direction and the rotation speed of each of the three motors to match a direction of the external force applied to the underground exploration apparatus with the movement direction of the one movement mode selected.

4. The underground exploration apparatus according to claim 1, wherein when a movement speed of the underground exploration apparatus approaches an upper limit movement speed, the calculation unit outputs warning information indicating that the underground exploration apparatus approaches the upper limit movement speed.

5. The underground exploration apparatus according to claim 2, wherein when a movement speed of the underground exploration apparatus approaches an upper limit movement speed, the calculation unit outputs warning information indicating that the underground exploration apparatus approaches the upper limit movement speed.

6. The underground exploration apparatus according to claim 3, wherein when a movement speed of the underground exploration apparatus approaches an upper limit movement speed, the calculation unit outputs warning information indicating that the underground exploration apparatus approaches the upper limit movement speed.
